(19) United States
(12) Patent Application Publication
(10) Pub. No.: US 2026/0012862 A1
(43) Pub. Date: Jan. 8, 2026

(54) METHODS AND APPARATUSES FOR RELAY RESELECTION AND FALLBACK OPERATIONS IN A UE-TO-UE RELAY SCENARIO

(71) Applicant: LENOVO (BEIJING) LIMITED, Beijing (CN)

(72) Inventors: Lianhai WU, Beijing (CN); Haiming WANG, Beijing (CN); Jing HAN, Beijing (CN); Ran YUE, Beijing (CN); Min XU, Beijing (CN)

(21) Appl. No.: 19/112,007

(22) PCT Filed: Nov. 3, 2022
(86) PCT No.: PCT/CN2022/129658

§ 371 Date: Mar. 14, 2025

(51) Int. Cl. H04W 36/00; H04W 24/08; H04W 88/04; H04W 92/18

(52) U.S. Cl. CPC H04W 36/033; H04W 24/08; H04W 88/04; H04W 92/18

(57) ABSTRACT

Embodiments of the present application relate to methods and apparatuses for relay reselection and fallback operations in a user equipment (UE)-to-UE relay scenario. According to an embodiment of the present application, a user equipment (UE) includes a transceiver and a processor coupled to the transceiver; and the processor is configured to: select a relay UE based on a relay selection operation; communicate with a further UE via the relay UE, wherein the UE and the further UE act as UE-to-UE (U2U) remote UEs; and perform at least one of: receiving a message from the relay UE and performing a relay reselection operation after receiving the message; or measuring quality of a direct PC5 link between the UE and the further UE.

### TECHNICAL FIELD

Embodiments of the present application generally relate to wireless communication technology, especially to methods and apparatuses for relay reselection and fallback operations in a user equipment (UE)-to-UE relay scenario.

### BACKGROUND

Vehicle to everything (V2X) has been introduced into 5G wireless communication technology. In terms of a channel structure of V2X communication, the direct link between two user equipments (UEs) is called a sidelink. A sidelink is a long-term evolution (LTE) feature introduced in 3GPP Release 12, and enables a direct communication between proximal UEs, and data does not need to go through a base station (BS) or a core network.

In the 3rd Generation Partnership Project (3GPP), deployment of a relay node (RN) in a wireless communication system is promoted. One objective of deploying a RN is to enhance the coverage area of a BS by improving the throughput of a UE that is located in the coverage or far from the BS, which can result in relatively low signal quality. A RN may also be named as a relay UE in some cases. A 3GPP 5G sidelink system including a relay UE may be named as a sidelink relay system.

Currently, in a 3GPP 5G wireless system or the like, details regarding how to design relay reselection and fallback operations in a UE-to-UE (U2U) relay scenario have not been specifically discussed yet.

### SUMMARY

Some embodiments of the present disclosure provide a first user equipment (UE). The first UE may include: a transceiver: and a processor coupled to the transceiver. The processor may be configured to: select a first relay UE based on a relay selection operation: communicate with a second UE via the first relay UE, wherein the first UE and the second UE act as UE-to-UE (U2U) remote UEs; and perform at least one of: receiving a first message from the relay UE and performing a relay reselection operation after receiving the first message: or measuring quality of a direct PC5 link between the first UE and the second UE.

In some embodiments of the present disclosure, the processor of the first UE is configured to receive, from a serving cell, at least one of: a first indication for indicating whether a Layer-2 (L2) U2U relay UE function is supported by the serving cell: or a second indication for indicating whether a discovery operation for a L2 U2U relay UE is supported by the serving cell.

In some embodiments of the present disclosure, at least one of the first indication or the second indication is broadcasted by the serving cell via system information.

In some embodiments of the present disclosure, the processor of the first UE is configured to: determine whether quality of the direct PC5 link between the first UE and the second UE is less than or equal to a first threshold associated with the relay selection operation: select the first relay UE if the quality of the direct PC5 link between the first UE and the second UE is less than or equal to the first threshold, wherein the first UE communicates with the second UE via the direct PC5 link before performing the relay selection operation: and transmit a second message to the second UE.

In some embodiments of the present disclosure, the processor of the first UE is configured to receive the first threshold associated with the relay selection operation from a serving cell.

In some embodiments of the present disclosure, the second message includes a third indication for indicating the second UE to perform a relay selection operation.

In some embodiments of the present disclosure, the processor of the first UE is configured to transmit a fourth indication to release PC5 link from an access stratum (AS) layer of the first UE to an upper layer of the first UE if quality of the direct PC5 link is less than or equal to the first threshold.

In some embodiments of the present disclosure, the fourth indication is used for triggering a PC5 unicast link release operation, and the second message is a PC5 unicast link release message which is transmitted by the upper layer of the first UE to the second UE.

In some embodiments of the present disclosure, the second message is at least one of: a PC5 unicast link release message: a radio resource control (RRC) reconfiguration sidelink message: or a notification message for sidelink.

In some embodiments of the present disclosure, the second message includes one or more UE identities of one or more candidate relay UEs.

In some embodiments of the present disclosure, the processor of the first UE is configured to receive a response message from the second UE, and the response message includes a UE identity of a second relay UE selected by the second UE.

In some embodiments of the present disclosure, the second relay UE is the same as or different from the first relay UE.

In some embodiments of the present disclosure, the processor of the first UE is configured to transmit a third message to a serving cell if the quality of the direct PC5 link is less than or equal to the first threshold, and the third message includes at least one of: the first UE is to act as the U2U remote UE; a request for a resource for a discovery procedure for the first relay UE: or a request for a resource for communicating with the second UE via the first relay UE.

In some embodiments of the present disclosure, the third message is a sidelink UE information message.

In some embodiments of the present disclosure, the processor of the first UE is configured to perform one of the following if the quality of the direct PC5 link is less than or equal to the first threshold: triggering a discovery procedure for the first relay UE: and releasing the direct PC5 link between the first UE and the second UE.

In some embodiments of the present disclosure, the quality of the direct PC5 link between the first UE and the second UE is measured after communicating with the second UE via the first relay UE, and the processor of the first UE is configured to receive at least one of the following from a serving cell: a second threshold associated with a fallback operation of the first UE: or a third threshold associated with the fallback operation of the first UE.

In some embodiments of the present disclosure, after measuring the quality of the direct PC5 link, the processor of the first UE is configured to: determine whether the quality of the direct PC5 link is greater than or equal to the second threshold: and perform the fallback operation to communicate with the second UE via the direct PC5 link if the quality of the direct PC5 link is greater than or equal to the second threshold.

In some embodiments of the present disclosure, after measuring the quality of the direct PC5 link, the processor of the first UE is configured to: determine whether the quality of the direct PC5 link is greater than or equal to the second threshold: determine whether quality of a PC5 link between the first UE and the first relay UE is less than or equal to the third threshold if the quality of the direct PC5 link is greater than or equal to the second threshold: and perform the fallback operation to communicate with the second UE via the direct PC5 link if the quality of the PC5 link between the first UE and the first relay UE is less than or equal to the third threshold.

In some embodiments of the present disclosure, the processor of the first UE is configured to: determine whether the quality of the PC5 link between the first UE and the first relay UE is less than or equal to a fourth threshold: and start to measure the quality of the direct PC5 link if the quality of the PC5 link between the first UE and the first relay UE is less than or equal to the fourth threshold.

In some embodiments of the present disclosure, to perform the fallback operation, the processor of the first UE is configured to: establish the direct PC5 link between the first UE and the second UE; and release the PC5 link between the first UE and the first relay UE.

In some embodiments of the present disclosure, the first message is at least one of: a PC5 unicast link release message: or a PC5 RRC message.

In some embodiments of the present disclosure, the first message includes a fifth indication for indicating the first UE to perform at least one of: the relay reselection operation: or stopping traffic between the relay UE and the first UE.

In some embodiments of the present disclosure, the first message includes one or more UE identities of one or more candidate relay UEs.

In some embodiments of the present disclosure, the one or more UE identities of the one or more candidate relay UEs are received by the relay UE from the second UE.

Some embodiments of the present application provide a relay UE. The relay UE may include: a transceiver; and a processor coupled to the transceiver. The processor may be configured to: establish a first PC5 radio resource control (RRC) link between the relay UE and a first UE; establish a second PC5 RRC link between the relay UE and a second UE, wherein the first UE and the second UE act as UE-to-UE (U2U) remote UEs: receive data from the first UE; and transfer the received data to the second UE.

In some embodiments of the present disclosure, the processor of the relay UE is configured to transmit a first message to a serving cell, and the first message includes at least one of: the relay UE is to act as a U2U relay UE: a request for a resource for a discovery procedure for at least one of the first UE or the second UE; or a request for a resource for communicating with the at least one of the first UE or the second UE.

In some embodiments of the present disclosure, the processor of the relay UE is configured to transmit a second message to the first UE, and wherein the second message is at least one of: a PC5 unicast link release message: or a PC5 RRC message.

In some embodiments of the present disclosure, the second message includes a first indication for indicating the first UE to perform at least one of: the relay reselection operation: or stopping traffic between the relay UE and the first UE.

In some embodiments of the present disclosure, the second message is transmitted in response to at least one of: an access stratum (AS) layer of the relay UE indicates an upper layer of the relay UE to release a PC5 link between the relay UE and the second UE: the relay UE receives a PC5 unicast link release message from the second UE: the relay UE receives configuration information regarding not to act as a U2U relay UE from a serving cell: the relay UE detects a radio link failure (RLF) of the PC5 link between the relay UE and the second UE: the relay UE determines that quality of the PC5 link between the relay UE and the second UE is less than or equal to a second threshold: or the relay UE receives a second indication from the second UE, wherein the second indication is associated with the relay reselection operation of the first UE.

In some embodiments of the present disclosure, the AS layer of the relay UE indicates the upper layer of the relay UE after: the AS layer of the relay UE detects the RLF of the PC5 link between the relay UE and the second UE: or the AS layer of the relay UE receives a third indication from an AS layer of the second UE, wherein the third indication indicates to release the PC5 link between the relay UE and the second UE.

In some embodiments of the present disclosure, the second message includes one or more UE identities of one or more candidate relay UEs.

In some embodiments of the present disclosure, the processor of the relay UE is configured to receive a third message from the second UE, and the third message includes the one or more UE identities of the one or more candidate relay UEs.

Some embodiments of the present application provide a network node (e.g., a BS). The network node may include: a transceiver: and a processor coupled to the transceiver. The processor may be configured to: transmit a first indication for indicating whether a Layer-2 (L2) UE-to-UE (U2U) relay user equipment (UE) function is supported by the network node to a UE: and receive a second indication from the UE, wherein the second indication indicates at least one of: the UE is to act as a U2U remote UE: or the UE is to act as a U2U relay UE.

In some embodiments of the present disclosure, the processor of the network node is configured to transmit at least one of the following to the UE if the second indication indicates that the UE is to act as the U2U remote UE: a first threshold associated with a relay selection operation of the UE: or a third indication for indicating whether a discovery operation for a L2 U2U relay UE is supported by the network node.

In some embodiments of the present disclosure, at least one of the first indication or the third indication is broadcasted by the network node via system information.

In some embodiments of the present disclosure, the processor of the network node is configured to receive a first message from the UE if the second indication indicates that the UE is to act as the U2U remote UE, and the first message includes at least one of: a request for a resource for a discovery procedure for a relay UE: or a request for a resource for communicating with a second UE via the relay UE, wherein the second UE acts as the U2U remote UE.

In some embodiments of the present disclosure, the first message is a sidelink UE information message.

In some embodiments of the present disclosure, the processor of the network node is configured to transmit at least one of the following to the UE if the second indication indicates that the UE is to act as the U2U remote UE: a second threshold associated with a fallback operation of the UE; or a third threshold associated with the fallback operation of the UE.

In some embodiments of the present disclosure, the processor of the network node is configured to receive a second message from the UE if the second indication indicates that the UE is to act as the U2U relay UE, and the second message includes at least one of: a request for a resource for a discovery procedure for at least one remote UE: or a request for a resource for communicating with the at least one remote UE.

Some embodiments of the present disclosure provide a method performed by a first user equipment (UE). The method may include: selecting a first relay UE based on a relay selection operation: communicating with a second UE via the first relay UE, wherein the first UE and the second UE act as UE-to-UE (U2U) remote UEs: and performing at least one of: receiving a first message from the relay UE and performing a relay reselection operation after receiving the first message: or measuring quality of a direct PC5 link between the first UE and the second UE.

Some embodiments of the present disclosure provide a method performed by a relay UE. The method may include: establishing a first PC5 radio resource control (RRC) link between the relay UE and a first UE; establishing a second PC5 RRC link between the relay UE and a second UE, wherein the first UE and the second UE act as UE-to-UE (U2U) remote UEs: receiving data from the first UE; and transferring the received data to the second UE.

Some embodiments of the present disclosure provide a method performed by a network node (e.g., a BS). The method may include: transmitting a first indication for indicating whether a Layer-2 (L2) UE-to-UE (U2U) relay user equipment (UE) function is supported by the network node to a UE; and receiving a second indication from the UE, wherein the second indication indicates at least one of: the UE is to act as a U2U remote UE: or the UE is to act as a U2U relay UE.

Some embodiments of the present application also provide an apparatus for wireless communications. The apparatus includes: a non-transitory computer-readable medium having stored thereon computer-executable instructions; a receiving circuitry: a transmitting circuitry; and a processor coupled to the non-transitory computer-readable medium, the receiving circuitry and the transmitting circuitry, wherein the computer-executable instructions cause the processor to implement any of the above-mentioned method performed by a UE, a relay UE, or a network node (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary V2X communication system in accordance with some embodiments of the present application.

FIG. 3 illustrates an exemplary flowchart of a sidelink RRC reconfiguration procedure in accordance with some embodiments of the present application.

FIG. 4 illustrates an exemplary flowchart of a sidelink UE information procedure in accordance with some embodiments of the present application.

FIG. 5 illustrates an exemplary flowchart of a Layer-2 link release procedure in accordance with some embodiments of the present application.

FIG. 6 illustrates a flow chart of a method performed by a UE in accordance with some embodiments of the present application.

FIG. 7 illustrates a flow chart of a method performed by a relay UE in accordance with some embodiments of the present application.

FIG. 8 illustrates a flow chart of a method performed by a network node in accordance with some embodiments of the present application.

FIG. 9 illustrates a flow chart of a method for a relay selection operation in accordance with some embodiments of the present application.

a

FIG. 10 illustrates a flow chart of a method for a relay reselection operation in accordance with some embodiments of the present application.

FIG. 11 illustrates a flow chart of a method for a fallback operation of a remote UE in accordance with some embodiments of the present application.

FIG. 12 illustrates a block diagram of an exemplary apparatus in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems: and moreover, the terminologies recited in the present application may change, which should not affect the principle of the present application.

FIG. 1 illustrates a schematic diagram of a wireless communication system in accordance with some embodiments of the present application.

As shown in FIG. 1, the wireless communication system 100 includes two UEs (i.e., UE 101a and UE 101b), a BS 102, and a relay UE 103 for illustrative purpose. Although a specific number of UE(s), relay UE(s), and BS(s) are depicted in FIG. 1, it is contemplated that any number of UE(s), relay UE(s), and BS(s) may be included in the wireless communication system 100.

Due to a far distance between UE 101a and UE 101b, these two UEs communicate with each other via relay UE 103. UE 101a and UE 101b may be connected to relay UE 103 via a network interface, for example, a PC5 interface as specified in 3GPP standard documents. UE 101a may be connected to BS 102 via a network interface, for example, a Uu interface as specified in 3GPP standard documents. Referring to FIG. 1, UE 101a is connected to relay UE 103 via PC5 link 1, UE 101b is connected to relay UE 103 via PC5 link 2, and UE 101a is connected to the BS 102 via a Uu link. In some embodiments of FIG. 1, relay UE 103 or UE 101b may be connected to a BS, e.g., BS 102 or a different BS not shown in FIG. 1. That is to say, UE 101a, UE 101b, or relay UE 103 may be connected to the same BS or different BSs.

In some embodiments of the present application, UE 101a, UE 101b, or relay UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

In some further embodiments of the present application, UE 101a, UE 101b, or relay UE 103 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, UE 101a, UE 101b, or relay UE 103 may include wearable devices, such as smart watches, fitness bands, optical head-mounted displays, or the like. Moreover, UE 101a, UE 101b, or relay UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

BS(s) 102 may be distributed over a geographic region. In certain embodiments of the present application, each of the BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an OFDM modulation scheme on the downlink (DL), and UE(s) 101 (e.g., UE 101a, UE 101b, or other similar UE) transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

UE(s) 101 may access BS(s) 102 to receive data packets from BS(s) 102 via a downlink channel and/or transmit data packets to BS(s) 102 via an uplink channel. In normal operation, since UE(s) 101 does not know when BS(s) 102 will transmit data packets to it, UE(s) 101 has to be awake all the time to monitor the downlink channel (e.g., a physical downlink control channel (PDCCH)) to get ready for receiving data packets from BS(s) 102. However, if UE(s) 101 keeps monitoring the downlink channel all the time even when there is no traffic between BS(s) 102 and UE(s) 101, it would result in significant power waste, which is problematic to a power limited UE or a power sensitive UE.

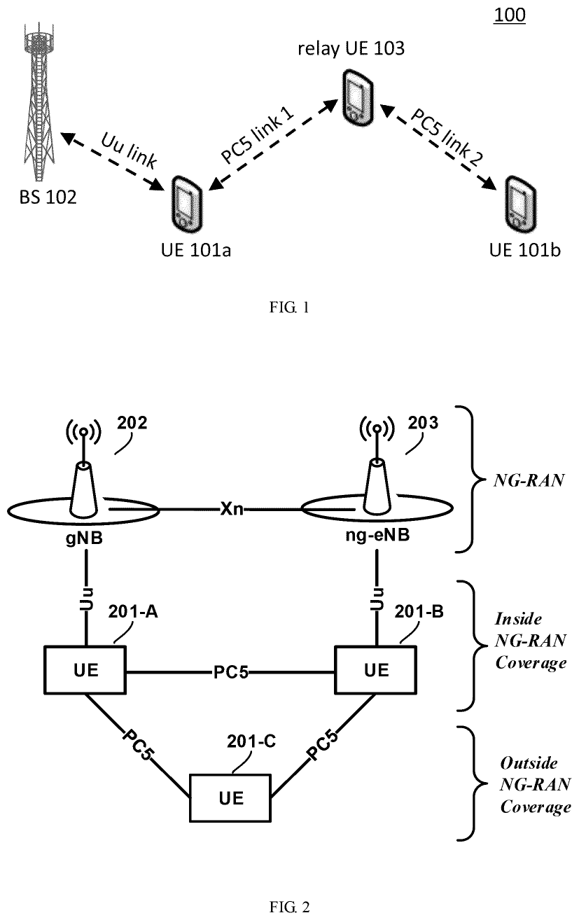

Generally, sidelink communication supports UE-to-UE (U2U) direct communication using two transmission modes. Two sidelink resource allocation modes are supported, namely, mode 1 and mode 2. In mode 1, the sidelink resource is scheduled by the BS. In mode 2, a UE decides the sidelink transmission resources and timing in the resource pool based on the measurement result and sensing result. Sidelink communication includes NR sidelink communication and V2X sidelink communication. FIG. 2 below demonstrates the NR sidelink communication. V2X sidelink communication is specified in 3GPP TS 36.300.

FIG. 2 illustrates an exemplary V2X communication system in accordance with some embodiments of the present application.

As shown in FIG. 2, the V2X communication system includes one gNB 202, one ng-eNB 203, and some V2X UEs, i.e., UE 201-A, UE 201-B, and UE 201-C. Each of these UEs may refer to UE 101a, UE 101b, or relay UE 103 as shown and illustrated in FIG. 1.

In particular, UE 201-A is within the coverage of gNB 202, UE 201-B is within the coverage of ng-eNB 203, and UE 201-C is out of coverage of gNB 202 and ng-eNB 203. Support of V2X services via the PC5 interface can be provided by NR sidelink communication and/or V2X sidelink communication. NR sidelink communication can support one of three types of transmission modes for a pair of a Source Layer-2 (L2) identity (ID) and a Destination L2 ID: unicast transmission: groupcast transmission: and broadcast transmission. Sidelink transmission and reception over the PC5 interface are supported when the UE is either inside of the NG-RAN coverage or outside of the NG-RAN coverage.

UE 201-A, which is within the coverage of gNB 202, may perform sidelink unicast transmission, sidelink groupcast transmission, or sidelink broadcast transmission over the PC5 interface. UE 201-C, which is out of coverage, can also perform sidelink transmission and reception over the PC5 interface. It is contemplated that, in accordance with some other embodiments of the present application, a V2X communication system may include more or fewer BSs, and more or fewer V2X UEs. Moreover, it is contemplated that names of V2X UEs (which represent a Tx UE, an Rx UE, and etc.) as illustrated and shown in FIG. 2 may be different, e.g., UE 201c, UE 204f, and UE 208g or the like.

In addition, although each V2X UE as shown in FIG. 2 is illustrated in the shape of a cell phone, it is contemplated that a V2X communication system may include any type of UE (e.g., a roadmap device, a cell phone, a computer, a laptop, IoT (internet of things) device or other type of device) in accordance with some other embodiments of the present application.

According to some embodiments of FIG. 2, UE 201-A functions as a Tx UE, and UE 201-B and UE 201-C function as an Rx UE. UE 201-A may exchange V2X messages with UE 201-B, or UE 201-C through a sidelink, for example, PC5 interface as defined in 3GPP TS 23.303. UE 201-A may transmit information or data to other UE(s) within the V2X communication system, through sidelink unicast, sidelink groupcast, or sidelink broadcast. The sidelink communication includes NR sidelink communication, and V2X sidelink communication. For instance, UE 201-A may transmit data to UE 201-C in a NR sidelink unicast session, and UE 201-B may transmit data to UE 201-C in a V2X sidelink unicast session. UE 201-A may transmit data to UE 201-B and UE 201-C in a groupcast group by a sidelink groupcast transmission session.

Sidelink communication includes NR Sidelink communication and V2X Sidelink communication. FIG. 2 demonstrates the NR Sidelink communication specified in 3GPP TS 38.311. V2X sidelink communication is specified in 3GPP TS 36.311.

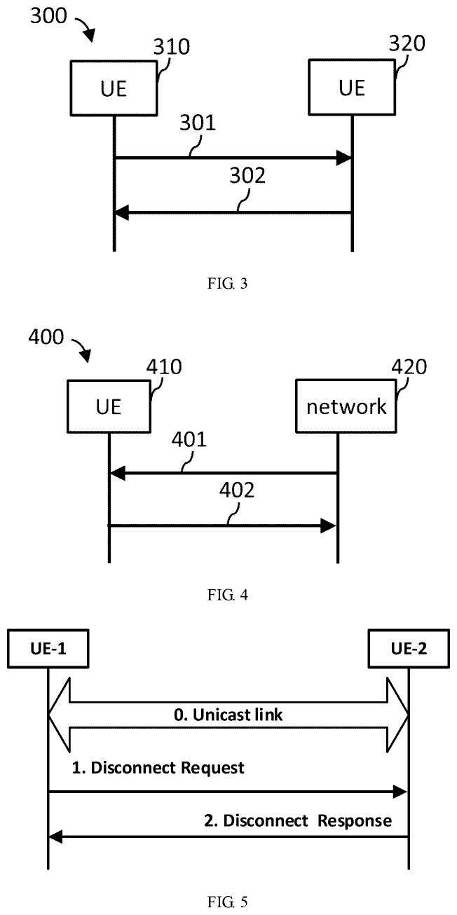

FIG. 3 illustrates an exemplary flowchart of a sidelink RRC reconfiguration procedure in accordance with some embodiments of the present application.

As shown in FIG. 3, in operation 301, UE 310 (e.g., UE 101a as illustrated and shown in FIG. 1) initiates a sidelink RRC reconfiguration procedure to UE 320 (e.g., relay UE 103 as illustrated and shown in FIG. 1) by transmitting RRCReconfigurationSidelink message to UE 320. In some embodiments, when UE 310 transmits RRCReconfigurationSidelink message, UE 310 may start timer T400.

If the sidelink RRC reconfiguration procedure is successfully completed, in operation 302, UE 320 may transmit “a RRC reconfiguration complete sidelink message” to UE 310, e.g., RRCReconfigurationCompleteSidelink message as specified in 3GPP standard documents. Alternatively, if the sidelink RRC reconfiguration procedure is not successfully completed, in operation 302, UE 320 may transmit “a RRC reconfiguration failure sidelink message” to UE 310, e.g., RRCReconfigurationFailureSidelink message as specified in 3GPP standard documents.

The purpose of a sidelink RRC reconfiguration procedure is to modify a PC5 RRC connection, e.g., to establish, modify, or release sidelink data radio bearers (DRBs), to configure NR sidelink measurement and reporting, and to configure sidelink channel state information (CSI) reference signal resources.

A UE (e.g., UE 310 as illustrated and shown in FIG. 3) may initiate the sidelink RRC reconfiguration procedure and perform operations on the corresponding PC5 RRC connection in following cases:
a release of sidelink DRBs associated with a peer UE (e.g., UE 320 as illustrated and shown in FIG. 3);
an establishment of sidelink DRBs associated with the peer UE:
a modification for the parameters included in Sidelink radio bearer (SLRB)-Config of sidelink DRBs associated with the peer UE:
configuration information of the peer UE to perform NR sidelink measurement and report: and
configuration information of the sidelink CSI reference signal resources.

A UE capable of NR sidelink communication may initiate a procedure of sidelink UE information for NR, to report to a network or a BS that a sidelink radio link failure (RLF) (e.g., timer T400 expiry) or a sidelink RRC reconfiguration failure has been declared.

The following table shows an introduction of timer T400 as specified in 3GPP standard documents, including a starting condition, a stop condition, an operation at expiry, and a possible general name for the timer.

| Timer | Start | Stop | At expiry | Name |
|---|---|---|---|---|
| T400 | upon transmission of | upon reception of | perform the sidelink | a timer for |
| | RRCReconfigurationSidelink | RRCReconfiguration | RRC reconfiguration | transmission |
| | | FailureSidelink or | failure procedure as | of RRC |
| | | RRCReconfiguration | specified in sub-clause | reconfiguration |
| | | CompleteSidelink | 5.8.9.1.8 of TS38.331 | for sidelink |

FIG. 4 illustrates an exemplary flowchart of a sidelink UE information procedure in accordance with some embodiments of the present application.

As shown in FIG. 4, in operation 401, network 420 (e.g., BS 102 as illustrated and shown in FIG. 1) may transmit a message, e.g., SIB12 acquisition, to UE 410 (e.g., UE 101a as illustrated and shown in FIG. 1 or UE 310 as illustrated and shown in FIG. 3). In operation 402, UE 410 may transmit “a sidelink UE information message” to network 420, e.g., SidelinkUEinformationNR message as specified in 3GPP standard documents. Specifically, the SidelinkUEinformationNR message may include sidelink failure information. The sidelink failure information may include a sidelink destination ID and a sidelink failure cause.

According to 3GPP standard documents, in a Layer-2 link release procedure over a PC5 link, the PC5-S protocol shall support the Layer-2 link release functionality that is used to detect if a particular PC5 unicast link is still valid.

FIG. 5 illustrates an exemplary flowchart of a Layer-2 link release procedure in accordance with some embodiments of the present application.

As shown in FIG. 5, in step 0, UE-1 (e.g., UE 101a, UE 201-A, UE 310, or UE 410 as illustrated and shown in FIGS. 1-4) and UE-2 (e.g., relay UE 103, UE 201-C, or UE 320 as illustrated and shown in FIGS. 1-3) have a unicast link established. In step 1, UE-1 (e.g., UE 101a as illustrated and shown in FIG. 1) sends a Disconnect Request message to UE-2 (e.g., relay UE 103 as illustrated and shown in FIG. 1) in order to release the Layer-2 link and deletes all context data associated with the Layer-2 link. The Disconnect Request message includes Security Information. In step 2, upon reception of the Disconnect Request message, UE-2 may respond with a Disconnect Response message and deletes all context data associated with the Layer-2 link. The Disconnect Response message includes Security Information. The V2X layer of each UE informs the AS layer that the unicast link has been released. The V2X layer uses PC5 Link Identifier to indicate the released unicast link. This enables the AS layer to delete the context related to the released unicast link.

Currently, details regarding how to design relay reselection and fallback operations in a U2U relay scenario have not been specifically discussed yet. Embodiments of the present application aim to solve such issues. In some embodiments, considering the case that a direct PC5 link between a UE and another UE is established already, the mechanism of U2U relay selection is studied. In some embodiments, considering the case that a remote UE and another remote UE communicates via a U2U relay UE, the condition to trigger a relay UE to transmit a PC5 unicast link release message from the relay UE to the remote UE is introduced. In some embodiments, how a remote UE can differentiate between relay reselection and stopping traffic when another remote UE receives a PC5 unicast link release message from a relay UE is studied. In some embodiments, considering the case that a remote UE and another remote UE communicate via a U2U relay UE, the mechanism that the remote UE falls back to a direct PC5 link between the remote UE and the another remote UE is introduced. More details will be illustrated in the following text in combination with the appended drawings.

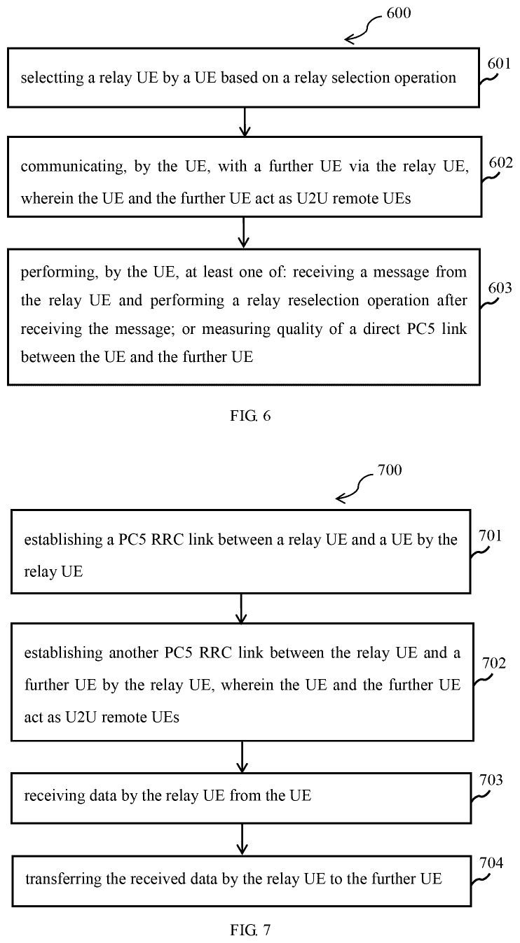

FIG. 6 illustrates a flow chart of a method performed by a UE in accordance with some embodiments of the present application.

The method may be performed by a UE (e.g., UE 101a or UE 101b as illustrated and shown in FIG. 1, UE 201-A or UE 201-B as illustrated and shown in FIG. 2, UE 310 or UE 320 as illustrated and shown in FIG. 3, UE 410 as illustrated and shown in FIG. 4, or UE-2 as illustrated and shown in FIG. 5). Although described with respect to a UE, it should be understood that other devices may be configured to perform a method similar to that of FIG. 6.

In the exemplary method 600 as shown in FIG. 6, in operation 601, a UE (e.g., UE 101a illustrated and shown in FIG. 1) may select a relay UE (e.g., relay UE 103 as illustrated and shown in FIG. 1) based on a relay selection operation.

In operation 602, the UE may communicate with a further UE (e.g., UE 101b illustrated and shown in FIG. 1) via the relay UE. For simplicity, the UE may be denoted as UE #1, the further UE may be denoted as UE #2, and the relay UE may be denoted as relay UE #1. UE #1 and UE #2 may act as U2U remote UEs.

In the embodiments of the present application, a link between UE #1 and relay UE #1 may also be named as “a first hop link between the UE and the relay UE,” “a first hop link,” or the like. An RRC relayed connection of a link between UE #1 and UE #2 may also be named as “an end-to-end RRC connection of a relayed link,” “an end-to-end RRC connection,” “an end-to-end relayed connection,” “a relayed RRC connection,” or the like.

In operation 603, UE #1 may perform at least one of:
(1) receiving a message (denoted as message #1) from the relay UE and performing a relay reselection operation after receiving message #1: or
(2) measuring quality of a direct PC5 link between UE #1 and UE #2.

In some embodiments, UE #1 may receive at least one of the following from a serving cell (e.g., BS 102 as illustrated and shown in FIG. 1):
(1) an indication (denoted as indication #1) for indicating whether a L2 U2U relay UE function is supported by the serving cell: or
(2) another indication (denoted as indication #2) for indicating whether a discovery operation for a L2 U2U relay UE is supported by the serving cell.

In some embodiments, at least one of indication #1 or indication #2 is broadcasted by the serving cell via system information, e.g., system information block 12 (SIB12).

In some embodiments, UE #1 may determine whether quality of the direct PC5 link between UE #1 and UE #2 is less than or equal to a threshold associated with the relay selection operation (denoted as threshold #1). UE #1 may select relay UE #1, via performing the relay selection operation if the quality of the direct PC5 link between UE #1 and UE #2 is less than or equal to threshold #1. Then, UE #1 may transmit another message (denoted as message #2) to UE #2. UE #1 may communicate with UE #2 via the direct PC5 link between UE #1 and UE #2 before performing the relay selection operation.

In an embodiment, threshold #1 may be configured by a network, e.g., if UE #1 is in-coverage of the network. For instance, UE #1 may receive configuration information regarding threshold #1 from a serving cell of the network (e.g., BS 102 as shown in FIG. 1). In another embodiment, threshold #1 may be pre-configured, e.g., if UE #1 is out of coverage (OOC) of the network.

In some embodiments, message #2 includes an indication (denoted as indication #3) for indicating UE #2 to perform the relay selection operation.

In some embodiments, UE #1 may transmit an indication to release PC5 link from an AS layer of UE #1 to an upper layer of UE #1 (e.g., a PC5-S layer of UE #1) if quality of the direct PC5 link is less than or equal to threshold #1. In an embodiment, this indication is used for triggering a PC5 unicast link release operation. In these embodiments, message #2 transmitted from UE #1 to UE #2 is a PC5 unicast link release message which is transmitted by the upper layer of UE #1 (e.g., a PC5-S layer) to UE #2. A specific example is described in Embodiment 1a of FIG. 9 as follows.

In some embodiments, message #2 transmitted from UE #1 to UE #2 is at least one of: a PC5 unicast link release message: an RRC reconfiguration sidelink message: or a notification message for sidelink. A specific example is described in Embodiment 1b of FIG. 9 as follows.

In some embodiments, message #2 transmitted from UE #1 to UE #2 includes one or more UE identities of one or more candidate relay UEs.

In some embodiments, UE #1 may receive a response message from UE #2, and the response message may include a UE identity of another relay UE (denoted as relay UE #2) selected by UE #2. For instance, relay UE #2 may be the same as or different from relay UE #1.

In some embodiments, UE #1 may transmit a message (denoted as message #3) to a serving cell if the quality of the direct PC5 link between UE #1 and UE #2 is less than or equal to threshold #1. For example, message #3 may include at least one of:
(1) UE #1 is to act as the U2U remote UE:
(2) a request for a resource for a discovery procedure for relay UE #1: or
(3) a request for a resource for communicating with UE #2 via relay UE #1.

In some embodiments, message #3 is a sidelink UE information message.

In some embodiments, if the quality of the direct PC5 link between UE #1 and UE #2 is less than or equal to threshold #1, UE #1 may trigger a discovery procedure for relay UE #1 or release the direct PC5 link between UE #1 and UE #2. Specific examples are described in the embodiments of FIG. 9 as follows.

In some embodiments, the quality of the direct PC5 link between UE #1 and UE #2 is measured by UE #1 in the case that UE #1 is communicating with UE #2 via relay UE #1, and UE #1 may receive at least one of the following from a serving cell (e.g., BS 102 as illustrated and shown in FIG. 1):
(1) a threshold (denoted as threshold #2) associated with a fallback operation of UE #1:
(2) another threshold (denoted as threshold #3) associated with the fallback operation of UE #1: or
(3) time duration related to threshold #2. Specific examples are described in the embodiments of FIG. 11 as follows.

In the embodiments of the subject application, when a remote UE (e.g., UE 190 1), which is communicating with a peer remote UE (e.g., UE #2) via a U2 U relay UE (e.g., relay UE #1), performs a fallback operation, the remote UE may release a PC5 link between the remote UE and the U2U relay UE and communicate with the peer remote UE via a direct PC5 link between the remote UE and the peer remote UE. Namely, by performing a fallback operation, the remote UE may switch back from the U2U relay operation to the direct PC5 link between the remote UE and the peer remote UE.

In some embodiments, after measuring the quality of the direct PC5 link between UE #1 and UE #2, UE #1 may determine whether the quality of the direct PC5 link between UE #1 and UE #2 is greater than or equal to threshold #2. If the quality of the direct PC5 link is greater than or equal to threshold #2, UE #1 may perform the fallback operation to communicate with UE #2 via the direct PC5 link between UE #1 and UE #2.

In an embodiment, if UE #1 receives configuration information regarding time duration related to threshold #2 from the serving cell, if UE #1 determines that the quality of the direct PC5 link is greater than or equal to threshold #2 within the time duration, UE #1 may perform the fallback operation to communicate with UE #2 via the direct PC5 link between UE #1 and UE #2.

In some other embodiments, after measuring the quality of the direct PC5 link between UE #1 and UE #2, UE #1 may determine whether the quality of the direct PC5 link between UE #1 and UE #2 is greater than or equal to threshold #2. UE #1 may further determine whether quality of a PC5 link between UE #1 and relay UE #1 is less than or equal to threshold #3 if the quality of the direct PC5 link is greater than or equal to threshold #2. UE #1 may perform the fallback operation to communicate with UE #2 via the direct PC5 link if the quality of the PC5 link between UE #1 and relay UE #1 is less than or equal to threshold #3.

In an embodiment, if UE #1 receives configuration information regarding time duration related to threshold #2 from the serving cell, if UE #1 determines that the quality of the direct PC5 link is greater than or equal to threshold #2 within the time duration and determines that the quality of the PC5 link between UE #1 and relay UE #1 is less than or equal to threshold #3, UE #1 may perform the fallback operation to communicate with UE #2 via the direct PC5 link between UE #1 and UE #2.

In some embodiments, UE #1 may determine whether the quality of the PC5 link between UE #1 and relay UE #1 is less than or equal to a further threshold (denoted as threshold #4), and start to measure the quality of the direct PC5 link between UE #1 and UE #2 if the quality of the PC5 link between UE #1 and relay UE #1is less than or equal to threshold #4.

In some embodiments, to perform the fallback operation, UE #1 may establish the direct PC5 link between UE #1 and UE #2 and release the PC5 link between UE #1 and relay UE #1. Specific examples are described in the embodiments of FIG. 11 as follows.

In some embodiments, message #1 received in operation 603 may be at least one of: a PC5 unicast link release message: or a PC5 RRC message. In some embodiments, message #1 includes an indication for indicating UE #1 to perform at least one of: the relay reselection operation: or stopping traffic between relay UE #1 and UE #1.

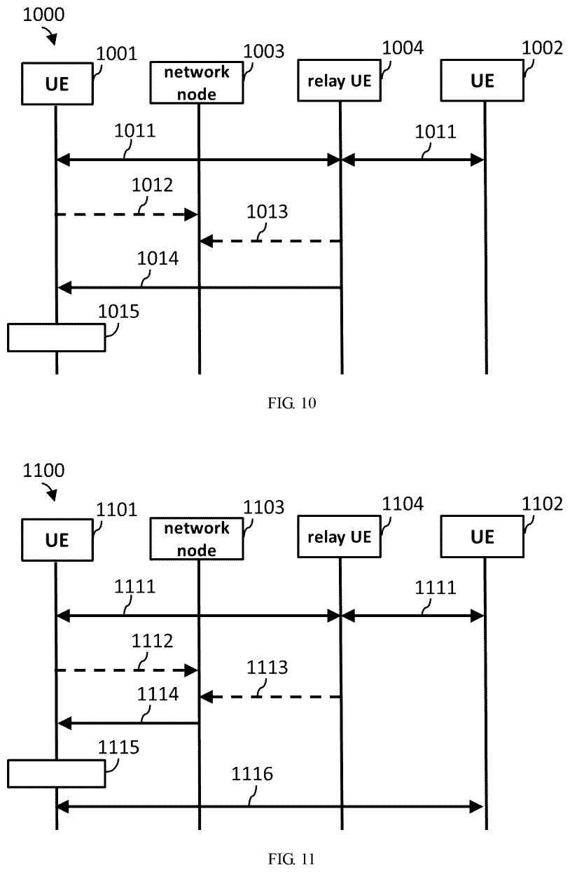

In some embodiments, message #1 includes one or more UE identities of one or more candidate relay UEs. In an embodiment, the one or more UE identities of the one or more candidate relay UEs are received by relay UE #1 from UE #2. Specific examples are described in the embodiments of FIG. 10 as follows.

Details described in all other embodiments of the present application (for example, details regarding relay reselection and fallback operations in a U2U relay scenario) are applicable for the embodiments of FIG. 6. Moreover, details described in the embodiments of FIG. 6 are applicable for all the embodiments of FIGS. 1-5 and 7-12.

FIG. 7 illustrates a flow chart of a method performed by a relay UE in accordance with some embodiments of the present application.

The method may be performed by a relay UE (e.g., relay UE 103 as illustrated and shown in FIG. 1, UE 201-C as illustrated and shown in FIG. 2, UE 310 or UE 320 as illustrated and shown in FIG. 3, UE 410 as illustrated and shown in FIG. 4, or UE-1 as illustrated and shown in FIG. 5). Although described with respect to a relay UE, it should be understood that other devices may be configured to perform a method similar to that of FIG. 7.

In the exemplary method 700 as shown in FIG. 7, in operation 701, a relay UE (e.g., relay UE 103 as illustrated and shown in FIG. 1) may establish a PC5 RRC link between the relay UE and a UE (e.g., UE 101a illustrated and shown in FIG. 1 or UE #1 in the embodiments of FIG. 6). In operation 702, the relay UE may establish another PC5 RRC link between the relay UE and a further UE (e.g., UE 101b illustrated and shown in FIG. 1 or UE #2 in the embodiments of FIG. 6). The UE and the further UE act as U2U remote UEs. In operation 703, the relay UE may receive data from the UE. In operation 704, the relay UE may transfer the received data to the further UE.

In some embodiments, the relay UE may transmit a message (denoted as message #4) to a serving cell (e.g., BS 102 as shown in FIG. 1 or a different BS not shown in FIG. 1). For example, message #4 may include at least one of:
(1) the relay UE is to act as a U2U relay UE:
(2) a request for a resource for a discovery procedure for at least one of the UE or the further UE: or
(3) a request for a resource for communicating with the at least one of the UE or the further UE. A specific example is described in the embodiments of FIG. 9 as follows.

In some embodiments, the relay UE may transmit a further message (e.g., message #1 in the embodiments of FIG. 6) to the UE. The further message may be at least one of: a PC5 unicast link release message: or a PC5 RRC message. In some embodiments, the further message includes an indication for indicating the UE to perform at least one of: the relay reselection operation: or stopping traffic between the relay UE and the UE.

In some embodiments, the further message (e.g., message #1 in the embodiments of FIG. 6) is transmitted by the relay UE to the UE in response to at least one of the following:
(1) An AS layer of the relay UE indicates an upper layer of the relay UE (e.g., a PC5-S layer of the relay UE) to release a PC5 link between the relay UE and the further UE. In an embodiment, the AS layer of the relay UE indicates the upper layer of the relay UE after: the AS layer of the relay UE detects the RLF of the PC5 link between the relay UE and the further UE; or the AS layer of the relay UE receives another indication from an AS layer of the further UE. This indication may indicate to release the PC5 link between the relay UE and the further UE.
(2) The relay UE receives a PC5 unicast link release message from the further UE.
(3) The relay UE receives “configuration information regarding not to act as a U2U relay UE” from a serving cell (e.g., BS 102 as shown in FIG. 1 or a different BS not shown in FIG. 1).
(4) The relay UE detects a RLF of the PC5 link between the relay UE and the further UE.
(5) The relay UE determines that quality of the PC5 link between the relay UE and the further UE is less than or equal to a further threshold.
(6) The relay UE receives a further indication from the further UE, and the further indication is associated with the relay reselection operation of the UE.

In some embodiments, the further message (e.g., message #1 in the embodiments of FIG. 6) includes one or more UE identities of one or more candidate relay UEs.

In some embodiments, the relay UE may receive another message from the further UE, and this message includes the one or more UE identities of the one or more candidate relay UEs. Specific examples are described in the embodiments of FIG. 10 as follows.

Details described in all other embodiments of the present application (for example, details regarding relay reselection and fallback operations in a U2U relay scenario) are applicable for the embodiments of FIG. 7. Moreover, details described in the embodiments of FIG. 7 are applicable for all the embodiments of FIGS. 1-6 and 8-12.

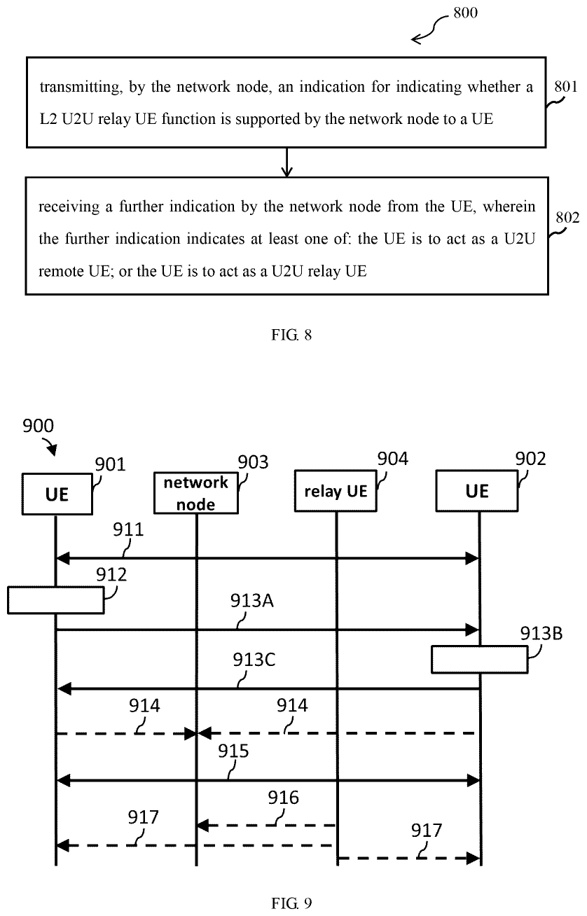

FIG. 8 illustrates a flow chart of a method performed by a network node in accordance with some embodiments of the present application.

The method may be performed by a network node (e.g., BS 102 illustrated and shown in FIG. 1, gNB 202 or ng-eNB 203 as illustrated and shown in FIG. 2, or network 420 as illustrated and shown in FIG. 4). Although described with respect to a network node (e.g., a BS), it should be understood that other devices may be configured to perform a method similar to that of FIG. 8.

In the exemplary method 800 as shown in FIG. 8, in operation 801, a network node (e.g., BS 102 illustrated and shown in FIG. 1) may transmit an indication (e.g., indication #1 in the embodiments of FIG. 6) for indicating whether a L2 U2U relay UE function is supported by the network node to a UE. The UE may act as a remote UE (e.g., UE 101a or UE 101b illustrated and shown in FIG. 1 or UE #1 or UE #2 in the embodiments of FIG. 6) or a relay UE (e.g., relay UE 103 illustrated and shown in FIG. 1 or relay UE #1 in the embodiments of FIG. 6). In operation 802, the network node may receive a further indication from the UE. The further indication may indicate at least one of: the UE is to act as a U2U remote UE: or the UE is to act as a U2U relay UE. For instance, the further indication may be included in message #3 in the embodiments of FIG. 6 or message #4 in the embodiments of FIG. 7.

In some embodiments, the network node may transmit at least one of the following to the UE if the further indication indicates that the UE is to act as the U2U remote UE:
(1) a threshold (e.g., threshold #1 in the embodiments of FIG. 6) associated with a relay selection operation of the UE; or
(2) another indication (e.g., indication #2 in the embodiments of FIG. 6) for indicating whether a discovery operation for a L2 U2U relay UE is supported by the network node.

In some embodiments, at least one of indication #1 or indication #2 is broadcasted by the network node via system information, e.g., SIB12.

In some embodiments, the network node may receive a message (e.g., message #3 in the embodiments of FIG. 6) from the UE if the further indication indicates that the UE is to act as the U2U remote UE (e.g., UE #1 in the embodiments of FIG. 6). In an embodiment, the message is a sidelink UE information message. The message may include at least one of:
(1) a request for a resource for a discovery procedure for a relay UE (e.g., relay UE #1 in the embodiments of FIG. 6); or
(2) a request for a resource for communicating with a further UE (e.g., UE #2 in the embodiments of FIG. 6) via the relay UE (e.g., relay UE #1 in the embodiments of FIG. 6), wherein the further UE acts as the U2U remote UE.

In some embodiments, the network node may transmit at least one of the following to the UE if the further indication indicates that the UE is to act as the U2U remote UE (e.g., UE #1 in the embodiments of FIG. 6):
(1) a threshold (e.g., threshold #2 in the embodiments of FIG. 6) associated with a fallback operation of the UE:
(2) another threshold (e.g., threshold #3 in the embodiments of FIG. 6) associated with the fallback operation of the UE; or
(3) time duration related to threshold #2. Specific examples are described in the embodiments of FIG. 11 as follows.

In some embodiments, the network node may receive a further message (e.g., message #4 in the embodiments of FIG. 7) from the UE if the further indication indicates that the UE is to act as the U2U relay UE (e.g., relay UE #1 in the embodiments of FIG. 6). The further message includes at least one of:
(1) a request for a resource for a discovery procedure for at least one remote UE (e.g., UE #1 and/or UE #2 in the embodiments of FIG. 6); or
(2) a request for a resource for communicating with the at least one remote UE.

Details described in all other embodiments of the present application (for example, details regarding relay reselection and fallback operations in a U2U relay scenario) are applicable for the embodiments of FIG. 8. Moreover, details described in the embodiments of FIG. 8 are applicable for all the embodiments of FIGS. 1-7 and 9-12.

The following texts describe specific embodiments of the methods as shown and illustrated in any of FIGS. 6-8.

FIG. 9 illustrates a flow chart of a method for a relay selection operation in accordance with some embodiments of the present application. According to the flow chart 900 in the embodiments of FIG. 9, UE 901 (e.g., UE 101a as shown and illustrated in FIG. 1), UE 902 (e.g., UE 101b as illustrated and shown in FIG. 1), network node 903 (e.g., BS 102 as illustrated and shown in FIG. 1), and relay UE 904 (e.g., relay UE 103 illustrated and shown in FIG. 1) perform the following operations, for example, in specific Embodiment 1a and Embodiment 1b of FIG. 9.

### Embodiment 1a

In operation 911, a PC5 RRC connection between UE 901 and UE 902 has been established. UE 901 and UE 902 may communicate with each other via a direct PC5 link.

In some embodiments, an indication to indicate whether a L2 U2U relay UE function is supported by this serving cell is broadcasted, e.g., via SIB12, for instance:
sl-L2U2U-Relay ENUMERATED {enabled}

In some embodiments, an indication to indicate whether a discovery operation for a L2 U2U relay UE is supported by this serving cell is broadcasted, e.g., via SIB12, for instance:
sl-L2U2U-Relay Discovery ENUMERATED {enabled}

In some embodiments, a threshold (e.g., threshold #1 in the embodiments of FIG. 6) for relay selection is configured by a network node 904 (e.g., in-coverage) or pre-configured (e.g., out of courage (OOC)).

In operation 912, UE 901 performs the measurement of the direct PC5 link between UE 901 and UE 902. UE1 may determine whether the quality of the direct PC5 link between UE1 and UE2 is less than the (pre-)configured threshold (e.g., threshold #1).

In some embodiments, once UE 901 determines that the quality of the PC5 link is less than the (pre-)configured threshold, UE 901 performs a relay selection operation in operation 912. In an embodiment, an AS layer of UE 901 may indicate to upper layer(s) of UE 901 (e.g., a PC5-S layer of UE 901) to trigger a PC5 unicast link release. In operation 913A, the upper layer(s) of UE 901 (e.g., the PC5-S layer) transmits a message (e.g., message #2 in the embodiments of FIG. 6) to UE 902. The message may be a PC5 unicast link release message. An indication to perform a relay selection operation (e.g., indication #3 in the embodiments of FIG. 6) could be added in message, e.g., the PC5 unicast link release message.

In operation 913B, after remote UE 902 receives the message, UE 902 performs a relay selection operation. The traffic between UE 901 and UE 902 will not be stopped. In operation 913C, UE 902 may transmit a response message to UE 901.

In some embodiments, the message transmitted from UE 901 in operation 913A may include one or more UE identities of one or more candidate relay UEs, e.g., which are included in a list of the one or more candidate relay UEs. If the one or more UE identities of one or more candidate relay UEs are included, UE 902 may select one candidate relay UE. A UE identity of the selected relay UE (e.g., relay UE 904) may be included in the response message transmitted from UE 902 to UE 901 in operation 913C.

In an embodiment, in operation 913B, UE 902 may reject all candidate relay UEs in the list of the one or more candidate relay UEs received from UE 901, and suggest other candidate relay UE(s), e.g., relay UE 904 in the case that relay UE 904 is not included in the list. UE identities of the other candidate relay UE(s) may be included in the response message transmitted from UE 902 to UE 901 in operation 913C.

In some other embodiments, once UE 901 determines that the quality of the direct PC5 link is less than the (pre-)configured threshold, UE 901 is triggered to perform a discovery procedure.

In some embodiments, once UE 901 determines that the quality of the direct PC5 link is less than the (pre-)configured threshold, UE 901 is triggered to release the current direct PC5 link between UE 901 and UE 902.

In some embodiments, once UE 901 determines that the quality of the PC5 link is less than the (pre-)configured threshold, UE 901 (i.e., the remote UE) may be triggered to report information to a serving cell (e.g., network node 903) via a sidelink UE information message if UE 901 is in the coverage of the serving cell.

In an embodiment, the information reported by UE 901 could be “UE 901 is to act as a U2U remote UE” and/or “UE 901 requests the discovery resource or the communication resource for U2U relay operation”.

In some embodiments, an RLF detection on the direct PC5 link can be used to trigger a relay selection operation.

In some embodiments, in operation 914 (optional), the U2U remote UE (e.g., UE 901 and/or UE 902) may report information to a serving cell, e.g., network node 903, via a sidelink UE information message if the remote UE is in the coverage of the serving cell. In an embodiment, the information could be ‘the UE is to act as a U2U remote UE’ or ‘the UE requests the discovery resource(s) or communication resource(s) for the U2U relay operation’.

In operation 915, after the relay selection operation, relay UE 904 may be selected, which may be named as U2U relay UE 904. UE 901 and UE 902 will act as remote UEs. The link between remote UE 901 and remote UE 902 via U2U relay UE 904 will be established.

In operation 916 (optional), relay UE 904 may report information to a network node (e.g., network node 903 or a different network node not shown in FIG. 9) via a sidelink UE information message if the relay UE 904 is in the coverage of the network node. In an embodiment, the information could be “UE 904 is to act as a UE-to-UE relay UE” or “UE 904 requests the discovery resource or the communication resource for U2U relay operation”.

In operation 917 (optional), U2U relay UE 904 may allocate a local UE ID for the U2U remote UE (e.g., UE 901 and/or UE 902). The local UE ID may be added in the header of the adaptation layer of the U2U remote UE. The adaptation layer is a new layer above the radio link control (RLC) layer of the U2U remote UE.

In some embodiments, if U2U relay UE 904 is in the coverage of a network node (e.g., network node 903 or a different network node not shown in FIG. 9), the local UE ID for the U2U remote UE (e.g., UE 901 and/or UE 902) could be allocated by the network node.

### Embodiment 1b

In operation 911, a PC5 RRC connection between UE 901 and UE 902 has been established. UE 901 and UE 902 may communicate with each other via a direct PC5 link.

In some embodiments, an indication to indicate whether a L2 U2U relay UE function is supported by this serving cell is broadcasted, e.g., via SIB12, for instance:
sl-L2U2U-Relay ENUMERATED {enabled}

In some embodiments, an indication to indicate whether a discovery operation for a L2 U2U relay UE is supported by this serving cell is broadcasted, e.g., via SIB12, for instance:
sl-L2U2U-Relay Discovery ENUMERATED {enabled}

In some embodiments, a threshold (e.g., threshold #1 in the embodiments of FIG. 6) for relay selection is configured by network node 904 (e.g., in-coverage) or pre-configured (e.g., out of courage (OOC)) to UE 901 and/or UE 902.

In operation 912, UE 901 performs the measurement of the direct PC5 link between UE 901 and UE 902. UE 901 may determine whether the quality of the direct PC5 link between UE 901 and UE 902 is less than the (pre-)configured threshold (e.g., threshold #1).

In some embodiments, once UE 901 determines that the quality of the PC5 link is less than the (pre-)configured threshold, UE 901 performs a relay selection operation in operation 912. In operation 913A, UE 901 may transmit a message (e.g., message #2 in the embodiments of FIG. 6) to UE 902, to indicate UE 902 to perform a relay selection operation. The message may be a PC5 RRC message. The indication for indicating UE 902 to perform a relay selection operation could be added in the PC5 RRC message. For example, an AS layer of UE 901 transmits an RRCReconfigurationSidelink message or a notification message for sidelink, to indicate UE 902 to perform a relay selection operation.

In operation 913B, after UE 902 receives the message (e.g., the PC5 RRC message), UE 902 may perform the relay selection operation. The traffic between UE 901 and UE 902 will not be stopped. In operation 913C, UE 902 may transmit a response message to UE 901.

In some embodiments, the message (e.g., the PC5 RRC message) transmitted from UE 901 in operation 913A may include one or more UE identities of one or more candidate relay UEs, e.g., which are included in a list of one or more candidate relay UEs. If the one or more UE identities of one or more candidate relay UEs are included in the message, UE 902 may select a candidate relay UE from the one or more candidate relay UEs. A UE identity of the selected relay UE (e.g., relay UE 904) may be included in the response message transmitted from UE 902 to UE 901 in operation 913C.

In an embodiment, in operation 913B, UE 902 may reject all candidate relay UEs in the list of the one or more candidate relay UEs in the message received from UE 901, and suggest other candidate relay UE(s). For example, UE 902 may suggest relay UE 904 as the candidate relay UE in the case that relay UE 904 is not included in the list. UE identities of the other candidate relay UE(s) may be included in the response message transmitted from UE 902 to UE 901 in operation 913C.

In some other embodiments, once UE 901 determines that the quality of the direct PC5 link between UE 901 and UE 902 is less than the (pre-)configured threshold, UE 901 is triggered to perform a discovery procedure, to discover a U2U relay UE, e.g., relay UE 904.

In some embodiments, once UE 901 determines that the quality of the direct PC5 link is less than the (pre-)configured threshold, UE 901 is triggered to release the current direct PC5 link between UE 901 and UE 902.

In some embodiments, once UE 901 determines that the quality of the PC5 link is less than the (pre-)configured threshold, UE 901 (i.e., the remote UE) may be triggered to report information to a serving cell (e.g., network node 903) via a sidelink UE information message if UE 901 is in the coverage of the serving cell. In an embodiment, the information reported by UE 901 could be “UE 901 is to act as a U2U remote UE” and/or “UE 901 requests the discovery resource or the communication resource for U2U relay operation”.

In some embodiments, an RLF detection on the direct PC5 link between UE 901 and UE 902 can be used to trigger a relay selection operation of UE 901.

In some embodiments, in operation 914 (optional), the U2U remote UE (e.g., UE 901 and/or UE 902) may report information to a serving cell, e.g., network node 903, via a sidelink UE information message if the remote UE is in the coverage of the serving cell. In an embodiment, the information could be ‘the UE is to act as a U2U remote UE’ or ‘the UE requests the discovery resource(s) or communication resource(s) for the U2U relay operation’.

In operation 915, after the relay selection operation of UE 901, relay UE 904 may be selected, which may be named as U2U relay UE 904. UE 901 and UE 902 will act as remote UEs. The link between remote UE 901 and remote UE 902 via U2U relay UE 904 will be established.

In operation 916 (optional), relay UE 904 may report information to a network node (e.g., network node 903 or a different network node not shown in FIG. 9) via a sidelink UE information message if the relay UE 904 is in the coverage of the network node. In an embodiment, the information could be “UE 904 is to act as a UE-to-UE relay UE” or “UE 904 requests the discovery resource or the communication resource for U2U relay operation”.

In operation 917 (optional), U2U relay UE 904 may allocate a local UE ID for the U2U remote UE (e.g., UE 901 and/or UE 902). The local UE ID may be added in the header of the adaptation layer of the U2U remote UE. The adaptation layer is a new layer above the radio link control (RLC) layer of the U2U remote UE.

In some embodiments, if U2U relay UE 904 is in the coverage of a network node (e.g., network node 903 or a different network node not shown in FIG. 9), the local UE ID for the U2U remote UE (e.g., UE 901 and/or UE 902) could be allocated by the network node.

FIG. 10 illustrates a flow chart of a method for a relay reselection operation in accordance with some embodiments of the present application. According to the flow chart 1000 in the embodiments of FIG. 10, remote UE 1001 (e.g., UE 101a as shown and illustrated in FIG. 1), remote UE 1002 (e.g., UE 101b as illustrated and shown in FIG. 1), network node 1003 (e.g., BS 102 as illustrated and shown in FIG. 1), and relay UE 1004 (e.g., relay UE 103 illustrated and shown in FIG. 1) perform the following operations.

In operation 1011, a PC5 RRC connection between remote UE 1001 and relay UE 1004 has been established. A PC5 RRC connection between remote UE 1002 and the same relay UE, i.e., relay UE 1004, has been established. Remote UE 1001 may transmit the data to remote UE 1002 via U2U relay UE 1004.

In some embodiments, the U2U remote UE (e.g., remote UE 1001 and/or remote UE 1002) may report information to a serving cell (e.g., network node 1003). In an embodiment, the information could be “the U2U remote UE is to act as a U2U remote UE” or “the U2U remote UE requests the discovery resource or the communication resource for U2U relay operation”. For example, in operation 1012 (optional), remote UE 1001 may report the information to network node 1003 via a sidelink UE information message if remote UE 1001 is in coverage of network node 1003.

In some embodiments, in operation 1013 (optional), U2U relay UE 1004 may report information to a serving cell (e.g., network node 1003 or a different network node not shown in FIG. 10) via a sidelink UE information message if U2U relay UE 1004 is in coverage of the serving cell. In an embodiment, the information could be “relay UE 1004 is to act as a U2U relay UE” or “relay UE 1004 requests the discovery resource or the communication resource for U2U relay operation”.

In operation 1014, relay UE 1004 transmits a message (e.g., message #1 in the embodiments of FIG. 6) to remote UE 1001, e.g., which may be a PC5 link release message or a PC5 RRC message. The message may include an indication, e.g., for indicating a relay reselection operation and/or stopping traffic between relay UE 1004 and remote UE 1001. For instance, the message, e.g., the PC5 link release message or the PC5 RRC message, may be transmitted based on at least one of the following conditions:
(1) An AS layer of relay UE 1004 indicates to upper layer(s) of relay UE 1004 (e.g., a PC5-S layer) to release a PC5 link between relay UE 1004 and remote UE 1002 after the AS layer of the relay UE detects a PC5 RLF of the PC5 link between relay UE 1004 and remote UE 1002 or receives an indication from the AS layer of UE 1002 that indicates to release the PC5 link between relay UE 1004 and remote UE 1002.
(2) Relay UE 1004 receives the PC5 unicast link release message from remote UE 1002.
(3) Relay UE 1004 receives “configuration information regarding not to be a U2U relay” from a serving cell (e.g., network node 1003 or a different network node not shown in FIG. 10).
(4) Relay UE 1004 detects a PC5 RLF of the PC5 link between relay UE 1004 and remote UE 1002. For example, relay UE 1004 may detect the PC5 RLF of the PC5 link in following cases:
   a) upon receiving an indication from a sidelink RLC entity that the maximum number of retransmissions for a specific destination has been reached: or
   b) upon timer T400 expiry for a specific destination; or
   c) upon receiving an indication from a medium access control (MAC) entity that the maximum number of consecutive hybrid automatic repeat request (HARQ) discontinuous transmission (DTX) for a specific destination has been reached: or
   d) upon receiving an integrity check failure indication from a sidelink packet data convergence protocol (PDCP) entity concerning sidelink-signaling radio bearer2 (SL-SRB2) or SL-SRB3 for a specific destination.
(5) In some embodiments, “aPC5 signal strength condition” may be used as a trigger condition for a remote UE (e.g., remote UE 1001 and/or remote UE 1002) to perform a relay reselection operation. In these embodiments, one threshold for triggering the relay reselection operation is configured to the remote UE, e.g., remote UE 1001 and/or remote UE 1002. Also, the threshold can be configured to a U2U relay UE (e.g., relay UE 1004) as well. For instance, if the relay UE determines that the quality of the link between relay UE 1004 and remote UE 1002 is less than the configured threshold, relay UE 1004 is triggered to transmit the indication, e.g., in the PC5 unicast link release message, to remote UE 1001, to trigger remote UE 1001 to perform a relay reselection operation.
(6) In some other embodiments, after remote UE 1002 detects that the quality of the link between relay UE 1004 and remote UE 1002 is less than the configured threshold, remote UE 1002 transmits the indication associated with the relay reselection operation to relay UE 1004. Then, relay UE 1004 may indicate to remote UE 1001 to perform a relay reselection operation.
   a) A candidate relay UE list can be exchanged between remote UE 1001 and remote UE 1002 before releasing the direct PC5 link. For example, when remote UE 1002 determines that the quality of the link between relay UE 1004 and remote UE 1002 is less than the configured threshold, remote UE 1002 transmits a message to remote UE 1001 via relay UE 1004. The message (e.g., message #1 in the embodiments of FIG. 6) may include a candidate relay UE list including UE identities of one or more candidate relay UEs. Remote UE 1001 may select a candidate relay UE in the candidate relay list and then transmit a response message to remote UE 1002. For example, the response message includes an UE ID of the selected candidate relay UE.
   b) In some embodiments, if no candidate relay in the candidate relay list is suitable, remote UE 1001 may suggest or select one or more other candidate relay UEs and transmit a response message to remote UE 1002. In these embodiments, multiple hops can be used as well. For example, the response message includes UE identities of the one or more other candidate relay UE(s).

In operation 1015, after remote UE 1001 receives the message (e.g., message #1 in the embodiments of FIG. 6) which includes the indication for indicating the relay reselection operation from relay UE 1004, remote UE 1001 may perform the relay reselection operation. Or, after remote UE 1001 receives the message which includes the indication for indicating traffic stopping from relay UE 1004, remote UE 1001 may release the direct PC5 link between relay UE 1004 and remote UE 1001 and does not perform the relay reselection operation.

FIG. 11 illustrates a flow chart of a method for a fallback operation of a remote UE in accordance with some embodiments of the present application. According to the flow chart 1100 in the embodiments of FIG. 11, UE 1101 (e.g., UE 10la as shown and illustrated in FIG. 1), UE 1102 (e.g., UE 101b as illustrated and shown in FIG. 1), network node 1103 (e.g., BS 102 as illustrated and shown in FIG. 1), and relay UE 1104 (e.g., relay UE 103 illustrated and shown in FIG. 1) perform the following operations.

In the embodiments of FIG. 11, when remote UE 1101, which is communicating with remote UE 1102 via U2U relay UE 1104, performs a fallback operation, remote UE 1101 may release a PC5 link between remote UE 1101 and U2U relay UE 1104 and then communicate with remote UE 1102 via a direct PC5 link between remote UE 1101 and remote UE 1102. Namely, by performing a fallback operation, remote UE 1101 may switch back from the U2U relay operation to the direct PC5 link between remote UE 1101 and remote UE 1102.

In operation 1111, a PC5 RRC connection between remote UE 1101 and relay UE 1104 has been established. A PC5 RRC connection between remote UE 1102 and the same relay UE, i.e., relay UE 1104, has been established. Remote UE 1101 may transmit the data to remote UE 1102 via relay UE 1104. Relay UE 1104 may be named as U2U relay UE 1104.

In some embodiments, in operation 1112 (optional), the U2U remote UE (e.g., remote UE 1101 and/or remote UE 1102) will report information to a serving cell (e.g., network node 1103 or a different network node not shown in FIG. 11) via a sidelink UE information message if the U2U remote UE is in coverage of the serving cell. In an embodiment, the information could be “the remote UE is to act as a U2U remote UE” or “the remote UE requests the discovery resource or the communication resource for U2U relay operation”.

In some embodiments, in operation 1113 (optional), relay UE 1104 will report information to a serving cell (e.g., network node 1103 or a different network node not shown in FIG. 11) via a sidelink UE information message if relay UE 1104 is in coverage of the serving cell. In an embodiment, the information could be “relay UE 1104 is to act as a U2U relay UE” or “U2U relay UE 1104 requests the discovery resource or the communication resource for U2U relay operation”.

In operation 1114, remote UE 1101 receives “one or more thresholds associated with a fallback operation of remote UE 1101” from network node 1103. In operation 1115, remote UE 1101 measures the quality of the direct PC5 link between remote UE 1101 and remote UE 1102.

In some embodiments, one threshold (e.g., threshold #2 in the embodiments of FIG. 6) associated with a fallback operation of remote UE 1101 for the direct PC5 link between remote UE 1101 and remote UE 1102 is configured to remote UE 1101. Once the quality of the direct PC5 link between remote UE 1101 and remote UE 1102 is better than the configured threshold, remote UE 1101 falls back (i.e., performing a fallback operation) to the direct PC5 link between remote UE 1101 and remote UE 1102. Namely, remote UE 1101 may establish the direct PC5 link to the remote UE 1102 and release the link between remote UE 1101 and relay UE 1104. Then, UE 1101 and UE 1102 do not act as remote UEs, and UE 1101 and UE 1102 communicate with each other via the direct PC5 link.

In an embodiment, the time duration related to the configured threshold (e.g., threshold #2 in the embodiments of FIG. 6) could be configured to remote UE 1101. For example, the condition associated with the threshold is needed within the time duration. In operation 1115, once the quality of the direct PC5 link is greater than or equal to the configured threshold within the time duration, remote UE 1101 falls back to the direct PC5 link between UE 1101 and UE 1102. Then, UE 1101 and UE 1102 do not act as remote UEs, and they will communicate with each other via the direct PC5 link.

In some embodiments, two thresholds (e.g., threshold #2 and threshold #3 in the embodiments of FIG. 6) are configured to remote UE 1101 for link switching. One threshold (e.g., threshold #2) is for the direct PC5 link between UE 1101 and UE 1102. Another threshold (e.g., threshold #3) is for the PC5 link between remote UE 1101 and relay UE 1104. For example, in operation 1115, once the quality of the direct PC5 link is greater than or equal to the configured threshold #2 and the quality of the PC5 link between remote UE 1101 and relay UE 1104 is less than or equal to the configured threshold #3, remote UE 1101 falls back to the direct PC5 link between UE 1101 and UE 1102. Then, UE 1101 and UE 1102 do not act as remote UEs, and they will communicate with each other via the direct PC5 link.

In some embodiments, in operation 1115, remote UE 1101 determines whether the quality of the PC5 link between remote UE 1101 and relay UE 1104 is less than or equal to another threshold (e.g., threshold #4 in the embodiments of FIG. 6): and remote UE 1101 starts to measure the quality of the direct PC5 link between UE 1101 and UE 1102, if the quality of the PC5 link between remote UE 1101 and relay UE 1104 is less than or equal to the abovementioned another threshold. Namely, when to monitor the direct PC5 link between UE 1101 and UE 1102 may be based on a trigger condition, e.g., which is associated with a threshold (e.g., threshold #4).

In operation 1116, remote UE 1101 communicates remote UE 1102 via the direct PC5 link without a relay UE, e.g., relay UE 1104.

Details described in all other embodiments of the present application (for example, details regarding how to design relay reselection and fallback operations in a U2U relay scenario) are applicable for the embodiments of any of FIGS. 8-11. Moreover, details described in the embodiments of any of FIGS. 8-11 are applicable for all embodiments of FIGS. 1-7 and 12. It should be appreciated by persons skilled in the art that the sequence of the operations in flow charts in the embodiments of any of FIGS. 8-11 may be changed and some of the operations in the flow charts in the embodiments of any of FIGS. 8-11 may be eliminated or modified, without departing from the spirit and scope of the disclosure.

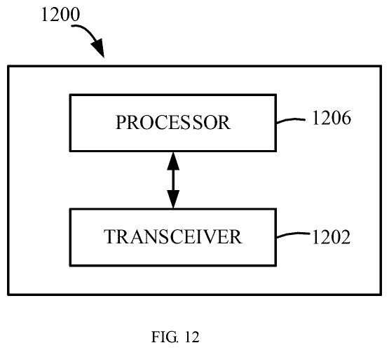

FIG. 12 illustrates a block diagram of an exemplary apparatus 1200 in accordance with some embodiments of the present application.

As shown in FIG. 12, the apparatus 1200 may include at least one processor 1206 and at least one transceiver 1202 coupled to the processor 1206. The apparatus 1200 may be a UE, a relay UE, or a network node (e.g., a BS).

Although in this figure, elements such as the at least one transceiver 1202 and processor 1206 are described in the singular, the plural is contemplated unless a limitation to the singular is explicitly stated. In some embodiments of the present application, the transceiver 1202 may be divided into two devices, such as a receiving circuitry and a transmitting circuitry. In some embodiments of the present application, the apparatus 1200 may further include an input device, a memory, and/or other components.

In some embodiments of the present application, the apparatus 1200 may be a UE. The transceiver 1202 and the processor 1206 may interact with each other so as to perform the operations with respect to the UEs described in FIGS. 1-11. In some embodiments of the present application, the apparatus 1200 may be a relay UE. The transceiver 1202 and the processor 1206 may interact with each other so as to perform the operations with respect to the relay UEs described in FIGS. 1-11. In some embodiments of the present application, the apparatus 1200 may be a network node (e.g., a BS). The transceiver 1202 and the processor 1206 may interact with each other so as to perform the operations with respect to the network node described in FIGS. 1-11.

In some embodiments of the present application, the apparatus 1200 may further include at least one non-transitory computer-readable medium. For example, in some embodiments of the present disclosure, the non-transitory computer-readable medium may have stored thereon computer-executable instructions to cause the processor 1206 to implement the method with respect to the UEs as described above. For example, the computer-executable instructions, when executed, cause the processor 1206 interacting with transceiver 1202 to perform the operations with respect to the UEs described in FIGS. 1-11.

In some embodiments of the present disclosure, the non-transitory computer-readable medium may have stored thereon computer-executable instructions to cause the processor 1206 to implement the method with respect to the relay UEs as described above. For example, the computer-executable instructions, when executed, cause the processor 1206 interacting with transceiver 1202 to perform the operations with respect to the relay UEs described in FIGS. 1-11.

In some embodiments of the present disclosure, the non-transitory computer-readable medium may have stored thereon computer-executable instructions to cause the processor 1206 to implement the method with respect to the network nodes (e.g., the BSs) as described above. For example, the computer-executable instructions, when executed, cause the processor 1206 interacting with transceiver 1202 to perform the operations with respect to the network nodes described in FIGS. 1-11.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “handover” and “path switch” may be used interchangeably. The terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, is defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A first user equipment (UE) for wireless communication, comprising:
at least one memory; and
at least one processor coupled with the at least one memory and configured to cause the first UE to:
select a first relay UE based on a relay selection operation;
communicate with a second UE via the first relay UE, wherein the first UE and the second UE act as UE-to-UE (U2U) remote UEs; and
perform at least one of:
receiving a first message from the relay UE and performing a relay reselection operation after receiving the first message; or
measuring quality of a direct PC5 link between the first UE and the second UE.

2. The first UE of claim 1, wherein the at least one processor is further configured to cause the first UE to: receive, from a serving cell, at least one of:
a first indication for indicating whether a Layer-2 (L2) U2U relay UE function is supported by the serving cell; or
a second indication for indicating whether a discovery operation for a L2 U2U relay UE is supported by the serving cell.

3. The first UE of claim 1, wherein the at least one processor is further configured to cause the first UE to:
determine whether a quality of the direct PC5 link between the first UE and the second UE is less than or equal to a first threshold associated with the relay selection operation;
select the first relay UE if the quality of the direct PC5 link between the first UE and the second UE is less than or equal to the first threshold, wherein the first UE communicates with the second UE via the direct PC5 link before performing the relay selection operation; and
transmit a second message to the second UE.

4. The first UE of claim 3, wherein the second message includes a third indication for indicating the second UE to perform a relay selection operation.

5. The first UE of claim 3, wherein the at least one processor is further configured to cause the first UE to transmit a fourth indication to release a PC5 link from an access stratum (AS) layer of the first UE to an upper layer of the first UE if a quality of the direct PC5 link is less than or equal to the first threshold.

6. The first UE of claim 5, wherein the fourth indication is used for triggering a PC5 unicast link release operation, and wherein the second message is a PC5 unicast link release message which is transmitted by the upper layer of the first UE to the second UE.

7. The first UE of claim 1, wherein the quality of the direct PC5 link between the first UE and the second UE is measured after communicating with the second UE via the first relay UE, and wherein the at least one processor is further configured to cause the first UE to receive at least one of the following from a serving cell:
a second threshold associated with a fallback operation of the first UE; or
a third threshold associated with the fallback operation of the first UE.

8. The first UE of claim 7, wherein, after measuring the quality of the direct PC5 link, the at least one processor is further configured to cause the first UE to:
determine whether the quality of the direct PC5 link is greater than or equal to the second threshold; and
perform the fallback operation to communicate with the second UE via the direct PC5 link if the quality of the direct PC5 link is greater than or equal to the second threshold.

9. The first UE of claim 7, wherein, after measuring the quality of the direct PC5 link, the at least one processor is further configured to cause the first UE to:
determine whether the quality of the direct PC5 link is greater than or equal to the second threshold;
determine whether a quality of a PC5 link between the first UE and the first relay UE is less than or equal to the third threshold if the quality of the direct PC5 link is greater than or equal to the second threshold; and
perform the fallback operation to communicate with the second UE via the direct PC5 link if the quality of the PC5 link between the first UE and the first relay UE is less than or equal to the third threshold.

10. A relay user equipment (UE) for wireless communication, comprising:
at least one memory; and
at least one processor coupled with the at least one memory and configured to cause the relay UE to:
establish a first PC5 radio resource control (RRC) link between the relay UE and a first UE;
establish a second PC5 RRC link between the relay UE and a second UE, wherein the first UE and the second UE act as UE-to-UE (U2U) remote UEs;
receive data from the first UE; and
transfer the received data to the second UE.

11. The relay UE of claim 10, wherein the at least one processor is further configured to cause the relay UE to: transmit a first message to a serving cell, and wherein the first message includes at least one of:
the relay UE is to act as a U2U relay UE;
a request for a resource for a discovery procedure for at least one of the first UE or the second UE; or
a request for a resource for communicating with the at least one of the first UE or the second UE.

12. The relay UE of claim 10, wherein the at least one processor is further configured to cause the relay UE to transmit a second message to the first UE, and wherein the second message is at least one of:
a PC5 unicast link release message; or
a PC5 RRC message.

13. The relay UE of claim 12, wherein the second message includes a first indication for indicating the first UE to perform at least one of:
the relay reselection operation; or
stopping traffic between the relay UE and the first UE.

14. The relay UE of claim 12, wherein the second message is transmitted in response to at least one of:
an access stratum (AS) layer of the relay UE indicates an upper layer of the relay UE to release a PC5 link between the relay UE and the second UE;
the relay UE receives a PC5 unicast link release message from the second UE;
the relay UE receives configuration information regarding not to act as a U2U relay UE from a serving cell;
the relay UE detects a radio link failure (RLF) of the PC5 link between the relay UE and the second UE;
the relay UE determines that quality of the PC5 link between the relay UE and the second UE is less than or equal to a second threshold; or
the relay UE receives a second indication from the second UE, wherein the second indication is associated with the relay reselection operation of the first UE.

15. A network node, comprising:
at least one memory; and
at least one processor coupled with the at least one memory and configured to cause the network node to:
transmit a first indication for indicating whether a Layer-2 (L2) UE-to-UE (U2U) relay user equipment (UE) function is supported by the network node to a UE; and
receive a second indication from the UE, wherein the second indication indicates at least one of:
the UE is to act as a U2U remote UE; or
the UE is to act as a U2U relay UE.

16. The first UE of claim 1, wherein the first message is a PC5 unicast link release message or a PC5 radio resource control (RRC) message.

17. The first UE of claim 4, wherein the second message is a PC5 unicast link release message, a radio resource control (RRC) reconfiguration sidelink message, or a notification message for sidelink

18. A method performed by a first user equipment (UE), the method comprising:
selecting a first relay UE based on a relay selection operation;
communicating with a second UE via the first relay UE, wherein the first UE and the second UE act as UE-to-UE (U2U) remote UEs; and
receiving a first message from the relay UE and performing a relay reselection operation after receiving the first message, or
measuring a quality of a direct PC5 link between the first UE and the second UE.

19. The method of claim 18, further comprising receiving, from a serving cell, at least one of:
a first indication for indicating whether a Layer-2 (L2) U2U relay UE function is supported by the serving cell; or
a second indication for indicating whether a discovery operation for a L2 U2U relay UE is supported by the serving cell.

20. The method of claim 18, further comprising:
determining whether a quality of the direct PC5 link between the first UE and the second UE is less than or equal to a first threshold associated with the relay selection operation;
selecting the first relay UE if the quality of the direct PC5 link between the first UE and the second UE is less than or equal to the first threshold, wherein the first UE communicates with the second UE via the direct PC5 link before performing the relay selection operation; and
transmitting a second message to the second UE.
